(19) United States
(12) Patent Application Publication
(10) Pub. No.: US 2019/0334188 A1
(43) Pub. Date: Oct. 31, 2019

(54) Fuel Battery System Provided with Hydrogen Generator

(71) Applicants: GIFU UNIVERSITY, Gifu (JP); SAWAFUJI ELECTRIC CO., LTD., Gunma (JP)

(72) Inventors: Shinji Kambara, Gifu (JP); Tomonori Miura, Gunma (JP)

(73) Assignees: GIFU UNIVERSITY, Gifu (JP); SAWAFUJI ELECTRIC CO., LTD., Gunma (JP)

(21) Appl. No.: 16/473,068

(22) PCT Filed: Jan. 19, 2018
(86) PCT No.: PCT/JP2018/001600

§ 371 Date: Jun. 24, 2019

(30) Foreign Application Priority Data
Jan. 30, 2017 (JP) 2017-013842

(51) Int. Cl. H01M 8/0606; C01B 3/50; C01B 3/04

(52) U.S. Cl. CPC H01M 8/0606; C01B 2203/041; C01B 3/047; C01B 3/503

(57) ABSTRACT

A compact fuel battery system is provided that has an integrated hydrogen generator. This fuel battery system 1 is provided with a hydrogen generator 10 and a fuel battery cell 20. The hydrogen generator 10 is provided with a plate-shape dielectric 2 having a raw material gas flow path surface 11 in which a raw material gas flow path 13 is formed. An electrode 3 faces the back surface 12 of the dielectric 2. A hydrogen separation membrane 5, which has a first surface 18 and the second surface 19, closes an opening of the raw material gas flow path 13. Furthermore, the hydrogen generator 10 is provided with a high-voltage power supply 6 which generates electric discharge between the hydrogen separation membrane 5 and the electrode 3. The fuel battery system is characterized in that the second surface 19 of the hydrogen separation membrane 5 of the hydrogen generator is arranged facing the fuel electrode 21 of the fuel battery cell 20.

### FIELD OF THE INVENTION

The present invention relates to a fuel battery system (fuel cell system) provided with a hydrogen generator, capable of generating high-purity hydrogen from a hydrogen raw material with a high yield.

### DESCRIPTION OF THE RELATED ART

A typical device that uses hydrogen as fuel is a fuel battery (or fuel cell). Fuel batteries require hydrogen of a high purity to run, and the standard for hydrogen purity for fuel batteries is currently defined in ISO 14687-2 as 99.97%. If a device could be provided that is capable of supplying hydrogen of a high purity directly to a fuel battery, it would be possible to make a small fuel battery system having an integrated fuel battery and hydrogen generator. Providing such a fuel battery system would expand the possible applications for fuel batteries.

An example of a known method for generating hydrogen for a fuel battery is steam reforming of hydrocarbon gas, such as methane. However, steam reforming requires processing at high temperatures using expensive catalysts such as nickel, which makes the production device as a whole expensive. Moreover, when the mole ratio of steam to the carbon contained in the hydrocarbon used as raw material becomes low, coking of the carbon on the catalyst occurs, which deactivates the catalyst. The production conditions must therefore be carefully controlled depending on the amount of hydrogen to be produced. Another known method of producing hydrogen is a catalysis method using a precious metal catalyst such as ruthenium to decompose a raw material such as ammonia at a temperature of 400° C. or higher. However, such catalysis methods have a low decomposition rate of the ammonia, and cannot generate hydrogen pure enough for use in fuel batteries at a high yield. Another method for producing hydrogen is disclosed in Patent Document 1, in which water vapor is introduced and hydrogen and oxygen is generated through high-temperature water vapor electrolysis. However, methods that use hot water vapor are not suitable for miniaturization of the device.

In addition, methods for transforming raw material gas into plasma to generate and separate hydrogen are being considered. Patent Document 2 discloses a hydrogen producing device including a plasma reactor into which a gaseous raw material is introduced, and a nearly cylindrical hydrogen separating/transporting section for separating hydrogen in the plasma reactor and transporting the obtained hydrogen to the outside of the plasma reactor. The outer wall of the plasma reactor also serves as an external electrode. The hydrogen separating/transporting section arranged coaxially with the external electrode is composed of a porous internal electrode and a hydrogen separating film with a thickness of a few ten μm to a few hundred μm coated on an internal surface of the internal electrode. Ferroelectric pellets of BaTiO₃ are filled between the external electrode and the hydrogen separating/transporting section.

Patent Document 3 discloses a hydrogen generating device including a plasma reactor, a high-voltage electrode, and a grounding electrode. In the hydrogen generating device of Patent Document 3 a hydrogen separation membrane functions as the high-voltage electrode, and hydrogen is generated by causing a dielectric barrier discharge between the hydrogen separation membrane and the grounding electrode under normal temperature and atmospheric conditions to transform the ammonia contained in the supplied gas into plasma.

The hydrogen generating devices using plasma discharge of Patent Documents 2 and 3 were generally cylindrical in shape, which imposed limits on miniaturization of the device as a whole when integrated with a fuel battery cell.

### PRIOR ART DOCUMENTS

Patent Document 1: Japanese Unexamined Patent Publication No. 2005-232536
Patent Document 2: Japanese Unexamined Patent Publication No. 2004-359508
Patent Document 3: Japanese Unexamined Patent Publication No. 2014-70012

### SUMMARY OF THE INVENTION

### Problem to be Solved by the Invention

The present invention was made in view of the aforementioned circumstances, and has an object of providing a small fuel battery system with an integrated hydrogen generator capable of generating hydrogen of a high purity.

### Means for Solving the Problem

The fuel battery system according to the present invention includes a hydrogen generator and a fuel battery cell. The hydrogen generator according to the present invention includes a plate-shaped dielectric with a raw material gas flow path surface having a raw material gas flow path formed as a groove with an opening, and a back surface approximately parallel relative to the raw material gas flow path surface, and further includes an electrode facing the back surface of the dielectric, a hydrogen separation membrane having a first surface and a second surface, the first surface facing the raw material gas flow path surface to close the opening of the raw material gas flow path, a high-voltage power supply for causing electric discharge in the raw material gas flow path between the hydrogen separation membrane and the electrode, and a spacer arranged at the peripheral edge of the second surface of the hydrogen separation membrane and bonded to the hydrogen separation membrane. The fuel battery system according to the present invention is characterized in that the second surface of the hydrogen separation membrane of the hydrogen generator and the fuel electrode of the fuel battery cell are arranged so as to face each other, and in that the space between the spacer and the fuel electrode of the fuel battery cell is sealed.

In the fuel battery system according to the present invention, the high-voltage power supply is preferably connected to at least one of the electrode or the hydrogen separation membrane.

The raw material gas flow path provided in the dielectric of the fuel battery system according to the present invention is preferably a groove composed of outgoing sections extending in straight or curved lines, and return sections extending back from the outgoing sections, the outgoing and return sections being alternately connected.

### Effects of the Invention

With the hydrogen separation membrane arranged so as to close the opening of the raw material gas flow path of the dielectric, the hydrogen generator according to the embodiment of the present invention is capable of transforming raw material gas in the raw material gas flow path into plasma in a uniform manner by causing an electric discharge between the hydrogen separation membrane and the electrode. Moreover, the hydrogen generated in the raw material gas flow path by plasma transformation passes through the hydrogen separation membrane and is directly introduced to the fuel electrode of the fuel battery as hydrogen-containing gas of a high purity. The fuel battery system according to the present invention can therefore generate hydrogen from the raw material gas at a high yield with a simpler configuration.

With the surfaces of the plate-shaped electrode, dielectric, and hydrogen separation membrane facing one another, the hydrogen generator of the fuel battery system according to the present invention can have approximately the same external measurements as the fuel battery cell. This facilitates integration and miniaturization of the hydrogen generator and fuel battery cell.

In the hydrogen generator according to the present invention, the raw material gas flow path is a groove in the form of a plurality of outgoing sections extending in a straight or a curved line and a plurality of return sections extending back from the outgoing sections, the outgoing sections and return sections being connected alternating with one another, and the hydrogen separation membrane is arranged facing the raw material gas flow path surface of the dielectric so as to close the opening of the raw material gas flow path groove. This way, the electric discharge between the hydrogen separation membrane and the electrode will occur transverse to the flow direction of the raw material gas. As a result, it is possible to supply electric power to the raw material gas in the hydrogen flow path for a long time, such that the raw material gas can be efficiently transformed into plasma in a uniform manner. This makes for very efficient hydrogen generation.

The cross-sectional shape of the groove constituting the raw material gas flow path, the total length of the raw material gas flow path, the contact area with the hydrogen separation membrane etc. of the dielectric of the hydrogen generator according to the present invention can easily be modified in accordance with the required amount of hydrogen to be generated.

### BRIEF DESCRIPTION OF THE DRAWINGS

FIG. 1 is a schematic perspective view of the fuel battery system according to an Example of the present invention.

FIG. 2 is an exploded perspective view of the fuel battery system according to an Example of the present invention.

FIG. 3 is an exploded perspective view of the fuel battery system according to an Example of the present invention.

FIG. 4 illustrates the difference in the generated hydrogen amounts of the hydrogen generator of the fuel battery system according to the present invention and a conventional hydrogen generation system.

FIG. 5 is an exploded perspective view of another Example of the fuel battery system according to the present invention.

FIG. 6 is a vertical cross-sectional view of a conventional cylindrical hydrogen generator.

### DESCRIPTION OF THE EMBODIMENTS

Below is an itemized description of a preferred embodiment of the present invention.

(1) The raw material gas used in the hydrogen generator is preferably ammonia, urea, or a hydrocarbon gas such as methane.

(2) The hydrogen separation membrane, when connected to the high-voltage power supply, functions as a high-voltage electrode. Conversely, when the hydrogen separation membrane is grounded, it functions as a grounding electrode.

(3) When the hydrogen separation membrane functions as a high-voltage electrode, the electrode arranged facing the back surface of the dielectric functions as a grounding electrode.

(4) When the hydrogen separation membrane of the hydrogen generator functions as a grounding electrode, the electrode arranged facing the back surface of the dielectric functions as a high-voltage electrode. At this time, a spacer consisting of an additional insulator is arranged outside of the high-voltage electrode.

(5) The high-voltage electrode and the grounding electrode face each other across the dielectric, and transform raw material gas in the raw material gas flow path into atmospheric pressure non-equilibrium plasma through dielectric barrier discharge. The high-voltage power supply applies a bipolar pulse waveform to the high-voltage electrode.

(6) The dielectric is formed of glass such as quartz glass, a ceramic such as alumina, or a highly insulating resin such as barium titanate, polycarbonate, or acryl.

(7) The raw material gas flow path is formed in the first surface of the dielectric, and consists of a plurality of outgoing sections extending in straight lines parallel to the top surface or side surface of the dielectric and a plurality of return sections extending back from and in parallel to the outgoing sections, the outgoing sections and return sections being alternately connected.

(8) The raw material gas flow path is formed in the raw material gas flow path surface of the dielectric, and consists of a plurality of outgoing sections extending at an angle relative to the side surface of the dielectric and a plurality of return sections extending back in hairpin turns at an angle relative to the outgoing sections, the outgoing sections and return sections being alternately connected.

(9) The raw material gas flow path is formed in the raw material gas flow path surface of the dielectric, and consists of a plurality of outgoing sections extending in curves or arcs, and a plurality of return sections extending back from the outgoing sections, the outgoing sections and return sections being alternately connected such that the path as a whole runs in a zig-zag pattern.

(10) The most preferable fuel battery cell used in the fuel battery system according to the present invention is a solid polymer fuel battery that operates at a temperature of 100° C. or lower. However, various other types of fuel battery cells may also be used in the fuel battery system according to the present invention.

(11) A distance is defined between the hydrogen separation membrane and the fuel battery cell by the spacer arranged between the second surface of the hydrogen separation membrane and the fuel electrode of the fuel battery cell. Preferably, the spacer is a frame having a uniform thickness and is arranged along the peripheral edge of the second surface of the hydrogen separation membrane, such that a closed space is formed by the hydrogen separation membrane, the spacer, and the fuel electrode.

### EXAMPLES

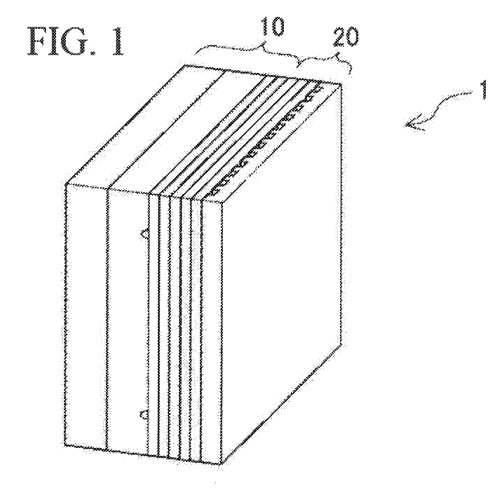

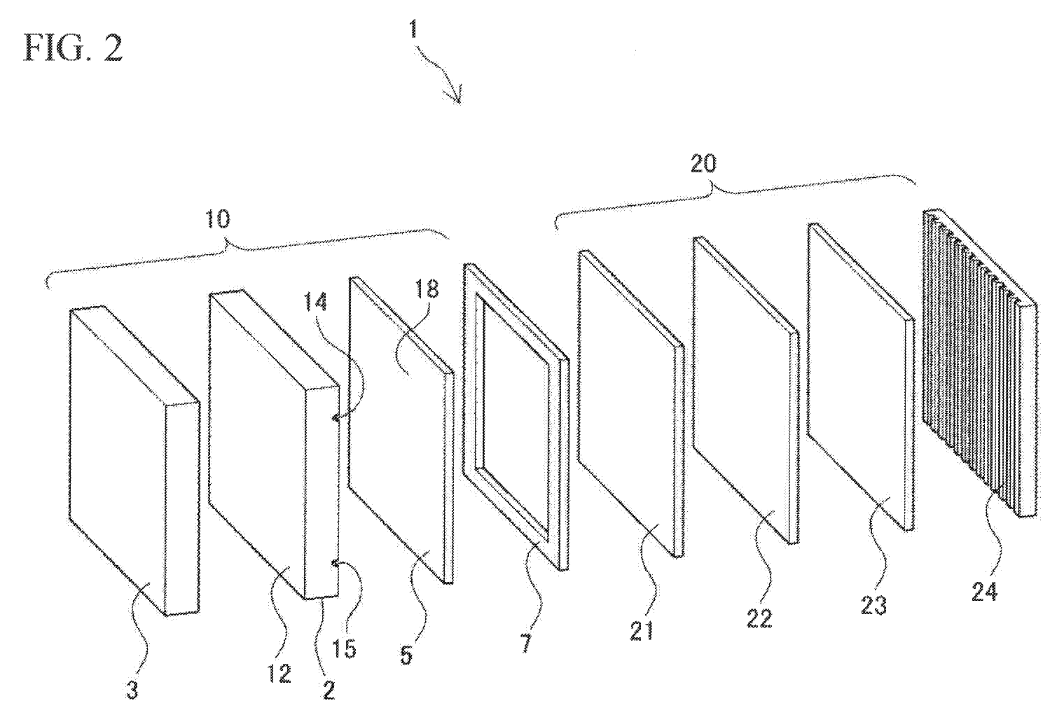

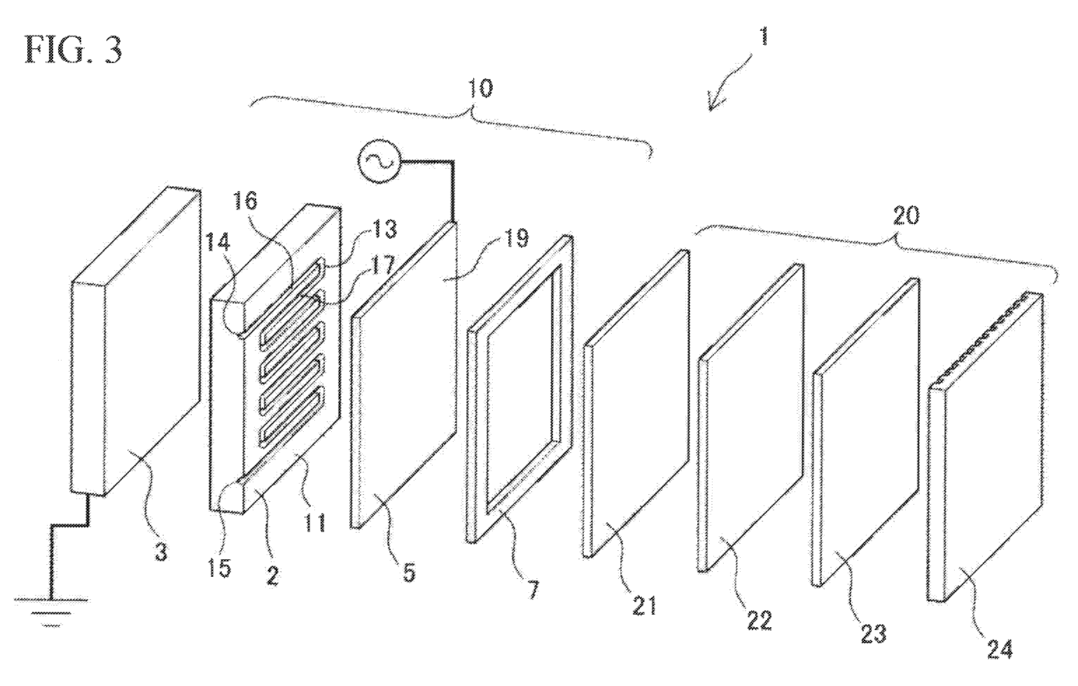

An Example of a fuel battery system 1 according to the present invention is described below with reference to the drawings. FIG. 1 is a schematic perspective view of the fuel battery system 1. The fuel battery system 1 includes a hydrogen generator 10 and a fuel battery cell 20. FIG. 2 is an exploded perspective view of the front, top, and left side surfaces of the components of the fuel battery system 1, and FIG. 3 is an exploded perspective view of the front, top, and right side surfaces of the components of the fuel battery system 1.

In the fuel battery system 1 according to the present Example, the hydrogen generator 10 includes a dielectric 2, an electrode 3, a hydrogen separation membrane 5, a high-voltage energy supply 6, and a spacer 7. The fuel battery cell 20 includes a fuel electrode 21, an electrolyte membrane 22, an air electrode 23, and a separator 24. In the following descriptions, the surfaces of the elements of the fuel battery system 1 shown on the right side of FIGS. 1 to 4 will be referred to as the right side surfaces. The right side surface of the dielectric 2 corresponds to a raw material gas flow path surface 11 of the dielectric 2. Likewise, the surfaces of the elements of the hydrogen generator 1 shown on the left side in FIGS. 1 to 4 will be referred to as the left side surfaces. The left side surface of the dielectric 2 corresponds to a back surface 12 of the dielectric 2.

The dielectric 2 is made of quartz glass and has the raw material gas flow path surface 11 in which there is formed a raw material gas flow path 13, and the second surface 12 that is approximately parallel relative to the raw material gas flow path surface 11. The raw material gas flow path 13 is formed as a groove open at the right side surface in the raw material gas flow path surface 11 of the dielectric 2. The shape of the raw material gas flow path 13 can be decided with consideration to the flow rate of the raw material gas and the voltage to be applied to the raw material gas. FIG. 2 shows an example in which the raw material gas flow path 13 has an outgoing section 16 that is in communication with a raw material gas flow path inlet 14 and extends linearly parallel to the top surface of the dielectric 2, and a return section 17 which extends back parallel to the outgoing section 16. A plurality of these outgoing sections 16 and return sections 17 are alternately connected at a uniform distance.

The electrode 3 is a plate-shaped electrode arranged so as to face the back surface 12 of the dielectric 2. As shown in FIG. 3, the electrode 3 is grounded, and functions as a grounding electrode.

A first surface 18 of the hydrogen separation membrane 5 is arranged facing the raw material gas flow path surface 11 of the dielectric 2 and closes the opening of the raw material gas flow path 13 of the dielectric 2. In the present embodiment, the cross-section of the raw material gas flow path 13 is defined as a closed cross-section by the dielectric 2 and the hydrogen separation membrane 5. A second surface 19 of the hydrogen separation membrane 5 is arranged facing the fuel electrode 21 of the fuel battery cell 20.

The frame-shaped spacer 7 is arranged between the second surface 19 of the hydrogen separation membrane 5 and the fuel electrode 21 of the fuel battery cell 20. The hydrogen separation membrane 5 and the spacer 7 are bonded together, and the space between the fuel electrode 21 and the spacer 7 is sealed. As a result, a closed space into which hydrogen is introduced is formed by the hydrogen separation membrane 5, the spacer 7, and the fuel electrode 21. The distance between the second surface 19 of the hydrogen separation membrane 5 and the fuel electrode 21 of the fuel battery cell 20 is defined by the spacer 7. The hydrogen separation membrane 5 transmits hydrogen generated from raw material gas in the raw material gas flow path 13. Hydrogen that has passed through the hydrogen separation membrane is introduced into the closed space formed on the side of the fuel electrode 21 and is supplied to the fuel electrode 21.

The hydrogen separation membrane 5 may be formed as a palladium alloy film, a zirconium-nickel (Zr—Ni) alloy film, a vanadium-nickel (V—Ni) alloy film, a niobium-nickel (Nb—Ni) alloy film, or a film consisting of an alloy of one or more metals of the group consisting of niobium (Nb), nickel (Ni), cobalt (Co), and molybdenum (Mo) with one or more metals of the group consisting of vanadium (V), titanium (Ti), zirconium (Zr), tantalum (Ta), and hafnium (Hf). For the hydrogen separation membrane 5 in the present example a palladium alloy film may particularly preferably be used. The hydrogen separation membrane 5 may be formed as a single layer film consisting of the aforementioned metals, or a laminate of two or more metals selected from the aforementioned metals. It is also possible to use a non-metallic hydrogen separation membrane such as a silica-based film, a zeolite-based film, a polyamide-based film, or a polysulfone-based film, but in such case a sturdier spacer 7 is bonded to the peripheral edge of the hydrogen separation membrane 5, and the hydrogen separation membrane 5 integrated with the spacer 7 is sandwiched between the dielectric 2 and the fuel electrode 21 to securely hold the hydrogen separation membrane 5.

The high-voltage power supply 6 is configured to cause an electric discharge in the raw material gas flow path 13 between the hydrogen separation membrane 5 and the electrode 3. In a preferred embodiment, the high-voltage power supply 6 is connected and applies a high voltage to the hydrogen separation membrane 5, causing the hydrogen separation membrane 5 to function as a high-voltage electrode. The high-voltage power supply 6 applies a bipolar pulse waveform with an extremely short retention time (T0) of 10 μs, which enables a high electronic energy density.

The dielectric 2, electrode 3, and hydrogen separation membrane 5 that constitute the hydrogen generator 10 may be configured in rectangular shapes with height and depth measurements that are generally identical to those of the fuel battery cell 20, giving the fuel battery system 1 including the hydrogen generator 10 and fuel battery cell 20 an approximately cuboidal shape. The elements of such a fuel battery system 1 may be stacked in this manner and then coupled firmly together using nuts and bolts. In order to securely seal the raw material gas flow path 13 and only supply hydrogen gas to the fuel battery cell 20, gaskets or sealants may be additionally provided.

In the hydrogen generator 10 of the fuel battery system 1 according to the present example, ammonia is most preferably used as the raw material. The reaction formula when using ammonia as the raw material to generate hydrogen is as shown in Formula 1 below.

2NH₃+e→N₂+3H₂+e (Formula 1)

A method for generating hydrogen with the hydrogen generator 10 using ammonia as the raw material gas will now be described. Raw material gas is fed by a raw material feed means (not shown) via the raw material gas flow path inlet 14 of the dielectric 2 to the raw material gas flow path 13 at a predetermined velocity. The high-voltage power supply 6 applies a voltage to the hydrogen separation membrane 5 to cause dielectric barrier discharge in the gas flow path 13 between the hydrogen separation membrane 5 and the electrode 3. This discharge transforms the ammonia in the gas flow path 13 into atmospheric pressure non-equilibrium plasma. The hydrogen generated from the atmospheric pressure non-equilibrium plasma is adsorbed by the hydrogen separation membrane 5 in the form of hydrogen atoms, which scatter as they pass through the hydrogen separation membrane 5 until they reach the space on the fuel electrode 21 side of the fuel battery cell 20, where they recombine into hydrogen molecules. In this way, the hydrogen separation membrane 5 allows only hydrogen to pass through to the fuel electrode 21 side, thereby separating the hydrogen.

Through sufficient control of the flow velocity of the ammonia flowing through the raw material gas flow path 13, time for the ammonia to be exposed to electric discharge can be secured, making it possible to separate almost 100% of the hydrogen contained in the ammonia and guide the hydrogen into the hydrogen flow path 18. Since the obtained hydrogen-containing gas has a purity of at least 99.999%, it can be used in the fuel battery cell 20 as is.

Moreover, the hydrogen generator 10 according to the present example operates in room temperature, and the high-purity hydrogen-containing that has passed through the hydrogen separation membrane 5 is also at room temperature. The hydrogen-containing gas can be introduced into the fuel battery cell 20 as is, without the need for any specific cooling treatment. The hydrogen generator 10 according to the present example can therefore, for example, be directly connected to the fuel battery cell 20 which is a solid polymer fuel battery cell operating at low temperatures to generate hydrogen.

The fuel battery cell 20 according to the present Example includes a fuel electrode 21, an electrolyte membrane 22, an air electrode 23, and a separator 24. The hydrogen molecules in the fuel electrode 21 become hydrogen ions and emit electrons. The hydrogen ions pass through the electrolyte membrane 22 and bond with oxygen supplied to the air electrode 23 to form water.

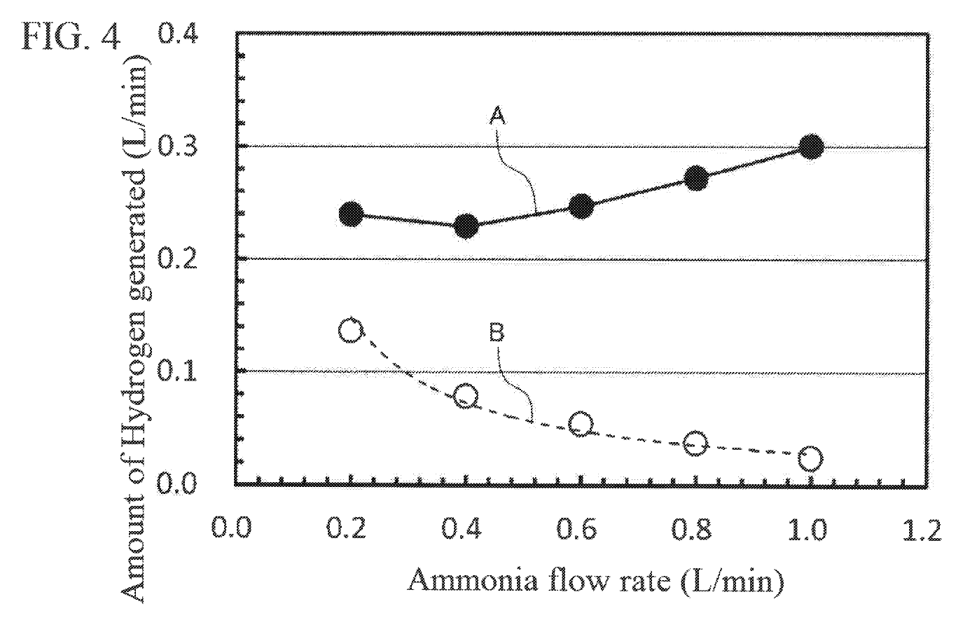

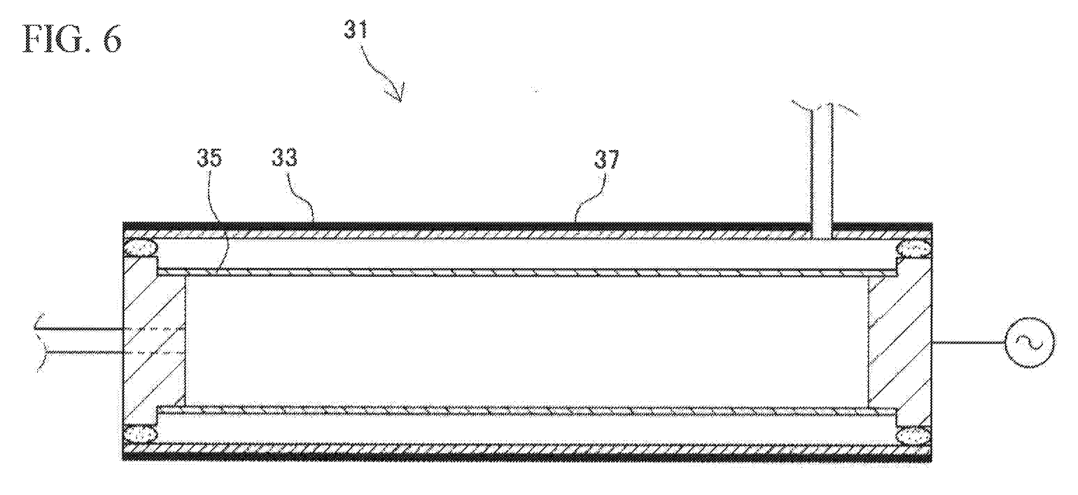

FIG. 4 is a graph showing the change in the amount of hydrogen generated relative to the amount of ammonia fed into the hydrogen generator 10. The amount of hydrogen generated is the flow rate of the hydrogen supplied to the fuel battery cell 20 from the hydrogen generator 10. The change in amount of hydrogen generated by the hydrogen generator 10 is indicated by the solid line A. For comparison, the amount of hydrogen generated by feeding ammonia to a cylindrical hydrogen generator 31 shown in FIG. 6 under identical conditions is indicated by the dashed line B. The purity of the hydrogen generated by either hydrogen generating device was 99.999%, which is very high. On the other hand, it is obvious from FIG. 4 that regardless of the flow rate of the ammonia, the hydrogen generator 1 according to the present invention was capable of generating hydrogen at a higher yield than the conventional cylindrical hydrogen generator 31, and the amount of hydrogen generated increased as the feed amount of ammonia increased. The cylindrical hydrogen generator 31 shown as a conventional example in FIG. 6 is a plasma reformer including a plasma reactor 33, a high-voltage electrode 35 housed inside the plasma reactor 33, and a grounding electrode 37 arranged in contact with the outside of the plasma reactor 33. In the cylindrical hydrogen generator 31, the high-voltage electrode 35 is composed of a hydrogen separation membrane which separates and introduces generated hydrogen into the space inside the device.

### Example 2

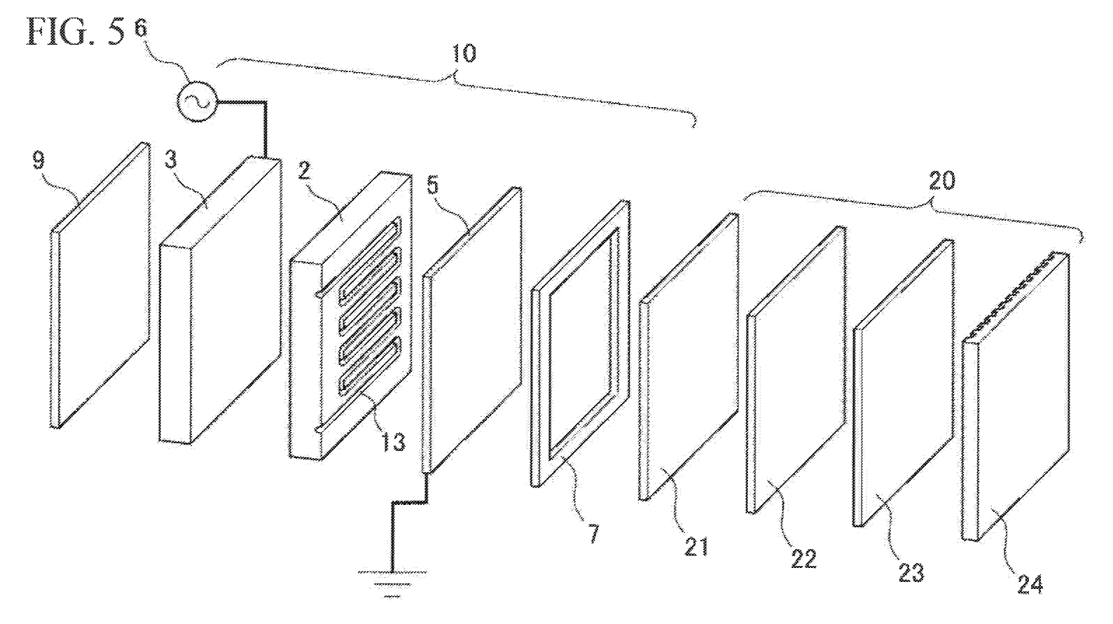

FIG. 5 shows another example of the fuel battery system 1 according to the present invention. In the hydrogen generator 10, the hydrogen separation membrane 5 is grounded via a ground wire and functions as a grounding electrode. Meanwhile, the electrode 3 is connected to the high-voltage power supply 6 and functions as a high-voltage electrode. An insulating spacer 9 is arranged on the outside of the electrode 3, and the spacer 7 is arranged between the hydrogen separation membrane 5 and the fuel electrode 21. In the present example, the high-voltage power supply 6 applies a voltage to the electrode 3 to cause dielectric barrier discharge in the raw material gas flow path 13 between the hydrogen separation membrane 5 and the electrode 3. This discharge transforms the ammonia in the raw material gas flow path 13 into atmospheric pressure non-equilibrium plasma, making it possible to generate hydrogen at a high yield and separate it as high-purity hydrogen by the hydrogen separation membrane 5 for supplying to the fuel battery cell 20.

The configuration of the fuel battery system 1 described in the Examples can be varied as necessary. The position and shape of the raw material gas flow path 13 formed in the dielectric 2 of the hydrogen generator 1 can be altered within the scope in which an electric discharge can be effected within the raw material gas flow path 13. For example, the path may be formed in the raw material gas flow path surface 11 of the dielectric 2 by an outgoing section extending at an angle relative to the side surface and a return section that extends back in a hairpin turn at an angle relative to the outgoing section, with a plurality of these outgoing sections and return sections being alternately connected. Alternatively, the raw material gas flow path 13 may be formed in the raw material gas flow path surface of the dielectric by a plurality of outgoing sections extending in curves or arcs, and a plurality of return sections extending back from the path sections, the path sections and return path sections being alternately connected such that the path as a whole runs in a zig-zag pattern.

Description of the Reference Numerals
1 fuel battery system
2 dielectric
3 electrode
5 hydrogen separation membrane
6 high-voltage power supply
7 spacer
8 grounding
9 spacer
10 hydrogen generator
11 raw material gas flow path surface
12 rear surface
13 raw material gas flow path
14 raw material gas flow path inlet
15 raw material gas flow path outlet
16 outgoing section of the raw material gas flow path
17 return section of the raw material gas flow path
18 first surface of the hydrogen separation membrane
19 second surface of the hydrogen separation membrane
20 fuel battery cell
21 fuel electrode
22 electrolyte membrane
23 air electrode
24 separator
31 cylindrical hydrogen generator
33 plasma reactor
35 high-voltage electrode
37 grounding electrode

1. A fuel battery system comprising a hydrogen generator and a fuel battery cell, characterized in that:
the hydrogen generator comprises:
a plate-shaped dielectric having a raw material gas flow path surface in which a raw material gas flow path is formed as a groove, and a back surface that is approximately parallel relative to the raw material gas flow path surface;
an electrode facing the back surface of the dielectric;
a hydrogen separation membrane having a first surface and a second surface, the first surface facing the raw material gas flow path surface, the hydrogen separation membrane closing an opening of the raw material gas flow path;
a high-voltage power supply configured to cause electric discharge in the raw material gas flow path between the hydrogen separation membrane and the electrode; and
a spacer arranged at a peripheral edge of the second surface of the hydrogen separation membrane and bonded to the hydrogen separation membrane,
wherein the second surface of the hydrogen separation membrane of the hydrogen generator and a fuel electrode of the fuel battery cell are arranged facing each other, and a space between the spacer and the fuel electrode of the fuel battery cell is sealed.

2. The fuel battery system according to claim 1, characterized in that the high-voltage power supply is connected to either one of the electrode or the hydrogen separation membrane.

3. The fuel battery system according to claim 1, characterized in that the raw material gas flow path is a groove composed of outgoing sections extending in straight or curved lines, and return sections extending back from the outgoing sections, the outgoing and return sections being alternately connected.
